(19) United States
(12) Patent Application Publication
(10) Pub. No.: US 2003/0213936 A1
(43) Pub. Date: Nov. 20, 2003

(54) Corrosion inhibiting formula and corrosion inhibiting articles using same

(75) Inventors: Donald A. Kubik, Dickenson, ND (US); Boris G. Varshal, Lynn, MA (US); Efim Ya. Lyublinski, Mayfield Heights, OH (US); Barbara A. Nygaard, Circle Pines, MN (US)

Correspondence Address: Alfred D. Lobo, LOBO & CO., L.P.A., 933 The Leader Building, 526 Superior Avenue, E., Cleveland, OH, 44114-1902, US

(73) Assignee: Northern Technologies International Corporation, Beachwood, OH

(21) Appl. No.: 10/453,304

(22) Filed: Jun. 3, 2003

Related U.S. Application Data
(63) Continuation of application No. 10/054,031, filed on Jan. 22, 2002, now abandoned.

(51) Int. Cl. C09K 3/00; C08K 3/34; C08K 11/00

(52) U.S. Cl. 252/387; 524/442; 524/492

(57) ABSTRACT

The present invention relates to corrosion inhibiting formulas. More particularly, in one embodiment the present invention relates to corrosion inhibiting formulas which comprise a mixture of: (i) at least one volatile corrosion inhibitor (VCI); (ii) at least one antioxidant; (iii) at least one alkali or alkaline-earth metal silicate or oxide; and (iv) fumed silica. In another embodiment, the present invention relates to corrosion inhibiting formulas which comprise a mixture of: (i) at least one volatile corrosion inhibitor (VCI); (ii) at least one antioxidant; (iii) at least one alkali or alkaline-earth metal silicate or oxide; (iv) fumed silica; and (v) at least one chemically active compound. Both of the mixtures described above can further include additional additives. In yet another embodiment, the corrosion inhibiting formulas according to the present invention can be placed in any suitable polymer film and/or polymer article.

### FIELD OF THE INVENTION

The present invention relates to corrosion inhibiting formulas. More particularly, in one embodiment the present invention relates to corrosion inhibiting formulas which comprise a mixture of: (i) at least one volatile corrosion inhibitor (VCI); (ii) at least one antioxidant; (iii) at least one alkali or alkaline-earth metal silicate or oxide; and (iv) fumed silica. In another embodiment, the present invention relates to corrosion inhibiting formulas which comprise a mixture of: (i) at least one volatile corrosion inhibitor (VCI); (ii) at least one antioxidant; (iii) at least one alkali or alkaline-earth metal silicate or oxide; (iv) fumed silica; and (v) at least one chemically active compound. Both of the mixtures described above can further include additional additives. In yet another embodiment, the corrosion inhibiting formulas according to the present invention can be placed in any suitable polymer film and/or polymer article.

### BACKGROUND OF THE INVENTION

In commerce and industry today, the useful life of corrodible items may be extended and/or preserved by providing corrosion inhibitors which protect the corrodible items from the adverse effects of its ambient environment. Among the common indications of corrosion manifested in useful metallic articles are oxidation, pitting, tarnishing, mottling, or discoloration of the surfaces of these items. These manifestations occur in metallic articles, particularly when exposed to oxygen, in either gaseous or liquid phase. Inasmuch as both oxygen and water, including water vapor, occur normally and are available in nature, it is normally necessary to take precautions against corrosion when packaging metallic items for shipment or storage, or when subjecting such items to normal use. Metals which are frequently found to be susceptible to corrosion under normal atmospheric and ambient conditions include, but are not limited to, iron, steel, copper, brass, aluminum, silver, and alloys of these metals.

Volatile or vapor phase corrosion inhibitors have been used in a variety of applications where visible coatings, such as oil or grease, or other permanent coatings, such as paints, are unacceptable for various reasons. Sodium nitrite, amine nitrite salts, organic amines, carboxylic acids and organic amine carboxylic acid salts have all been disclosed singularly and in combination in volatile corrosion inhibiting compositions (e.g. as described in U.S. Pat. Nos. 2,629,649; 2,711,360; 2,986,447; 3,398,095; 3,433,577; 3,785,975; and 3,967,926). Sheet materials useful for packaging metal parts containing volatile corrosion inhibiting compositions have also been disclosed (e.g., as described in U.S. Pat. Nos. 2,717,843; 2,739,871; 2,829,080; and 3,080,211). Sodium nitrite is known as an effective volatile corrosion inhibitor when carbon dioxide and water are present in the air. However, in the absence of carbon dioxide, its effectiveness as a volatile corrosion inhibitor drops off abruptly, as described in Metaux 1972 47(558), 41-50.

### SUMMARY OF THE INVENTION

The present invention relates to corrosion inhibiting formulas. More particularly, the present invention relates to a corrosion inhibiting formula which comprises a mixture of: (i) at least one volatile corrosion inhibitor (VCI); (ii) at least one antioxidant; (iii) at least one alkali or alkaline-earth metal silicate or oxide; and (iv) fumed silica.

In another embodiment, the present invention relates to a corrosion inhibiting formula which comprises a mixture of: (i) at least one volatile corrosion inhibitor (VCI); (ii) at least one antioxidant; (iii) at least one alkali or alkaline-earth metal silicate or oxide; (iv) fumed silica; and (v) at least one chemically active compound.

Both of the mixtures described above can further include additional additives.

In another embodiment, the present invention relates to a corrosion inhibiting polymer article comprising: about one part to about ten parts of a corrosion inhibiting mixture contained in a carrier the corrosion inhibiting mixture comprising: (i) at least one volatile corrosion inhibitor; (ii) at least one antioxidant; (iii) at least one alkali or alkaline-earth metal silicate or oxide; and (iv) fumed silica, and about ninety to about ninety-nine parts of at least one polymer composition or resin composition.

In another embodiment, the present invention relates to a corrosion inhibiting polymer article comprising: about one part to about ten parts of a corrosion inhibiting mixture contained in a carrier the corrosion inhibiting mixture comprising: (i) at least one volatile corrosion inhibitor; (ii) at least one antioxidant; (iii) at least one alkali or alkaline-earth metal silicate or oxide; (iv) fumed silica; and (v) at least one chemically active compound, and about ninety to about ninety-nine parts of at least one polymer composition or resin composition.

To the accomplishment of the foregoing and related ends, the invention, then, comprises the features hereinafter fully described and particularly pointed out in the claims. These embodiments are indicative, however, of but a few of the various ways in which the principles of the invention may be employed. Other objects, advantages and features of the invention will become apparent from the following detailed description of the invention.

### DETAILED DESCRIPTION OF THE INVENTION

As noted above, the present invention relates to corrosion inhibiting formulas. More particularly, in one embodiment the present invention relates to corrosion inhibiting formulas which comprise a mixture of: (i) at least one volatile corrosion inhibitor (VCI); (ii) at least one antioxidant; (iii) at least one alkali or alkaline-earth metal silicate or oxide; and (iv) fumed silica.

In another embodiment, the present invention relates to corrosion inhibiting formulas which comprise a mixture of: (i) at least one volatile corrosion inhibitor (VCI); (ii) at least one antioxidant; (iii) at least one alkali or alkaline-earth metal silicate or oxide; (iv) fumed silica; and (v) at least one chemically active compound.

Both of the mixtures described above can further include additional additives.

In yet another embodiment, such mixtures are combined with a small amount of a carrier (e.g., a polymer or resin material) to form a corrosion inhibiting mixture. This mixture can, if desired, be further processed by, for example, combining it with a suitable amount of polymer or resin and processing (e.g., by extrusion, co-extrusion, etc.) this mixture to form a polymer film or polymer article.

Additionally, it should be noted that in the following text, where utilized, range and ratio limits may be combined.

Volatile Corrosion Inhibitors:

Any suitable volatile corrosion inhibitor (or vapor phase corrosion inhibitor) can be utilized in the present invention. Some suitable volatile corrosion inhibitors are disclosed in U.S. Pat. Nos. 4,290,912; 5,320,778; and 5,855,975, which are all incorporated herein by reference in their entirety for their teachings of such compounds. For example, useful vapor phase or volatile corrosion inhibitors include, but are not limited to, triazoles and/or inorganic nitrites (e.g., nitrite salts).

In one embodiment, exemplary inorganic nitrite salts include, but are not limited to, metal nitrites such as sodium nitrite, potassium nitrite and barium nitrite. In another embodiment, any suitable Group 1 or Group 2 nitrite (New Notation System) can be used in the present invention.

In another embodiment, the one or more vapor phase or volatile corrosion inhibitor utilized in the present invention can be a triazole. Exemplary triazoles include, but are note limited to, benzotriazole, tolyltriazole and/or sodium tolyltriazole.

In yet another embodiment, the vapor phase or volatile corrosion inhibitor utilized in the present invention can be any suitable mixture of two or more of the above-mentioned inhibitors.

Antioxidants:

Any suitable antioxidant can be utilized in the present invention. Exemplary antioxidants include, but are not limited to, tri-substituted phenols substituted in the 2, 4 and 6 positions with one or more alkyl, hydroxyalkyl, aryl, alkenyl or hydroxyalkenyl groups of the general formula shown below.

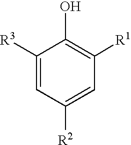

In one embodiment, the sum of the carbon atoms present in the substituent groups R¹, R² and R³ is in the range of 3 to about 36, or even in the range of 3 to about 18.

In another embodiment, a mixture of two or more of the above-mentioned antioxidants can be utilized in the present invention.

Alkali/Alkaline-Earth Metal Silicates/Oxides:

Any suitable Group 1 or 2 silicate or oxide can be utilized in the present invention. Exemplary silicates include lithium silicate, sodium silicate, potassium silicate and barium silicate. With regard to the silicates utilized in the present invention, the weight ratio of alkali or alkaline-earth metal oxide to silicate can vary. In one embodiment, this ratio of metal oxide to silicate is from about 5:1 to about 1:5, in another the weight ratio is about 3:1 to about 1:3.

In another embodiment, a mixture of one or more silicates can be used in the present invention. In yet another embodiment, the one or more silicates can be in a glassy or crystalline state.

In yet another embodiment, at least one alkali or alkaline-earth metal oxide is utilized in the present invention rather than, or in addition to, the one or more silicates discussed above. Exemplary alkali and alkaline-earth metal oxides include, but are not limited to, magnesium oxide, calcium oxide, strontium oxide and barium oxide. In another embodiment, a mixture of two or more alkali or alkaline-earth metal oxides can be utilized in the present invention.

Fumed Silica:

Any suitable fumed silica can be utilized in the present invention. Suitable fumed silicas are available under the tradenames Cab-O-Sil from Cabot Corporation and Aerosil from American Cyanamid.

Chemically Active Compound:

If present, the at least one chemically active compound utilized in the present invention can be an oxide compound, or combination thereof, which can react with one or more compounds to form compounds which are insoluble in aqueous environments. Exemplary chemically active compounds include iron oxides (both ferrous oxide and ferric oxide), cobalt oxide, nickel oxide, copper oxides (both cuprous oxide and cupric oxide) and zinc oxide.

In another embodiment, mixtures of two or more of the above-mentioned oxides can be utilized.

Carrier:

Any suitable carrier can be utilized to form a corrosion inhibiting mixture containing items (i) to (iv) (or (i) to (v)), as discussed above. Exemplary carriers include, but are not limited to, polymer and/or resin compositions (e.g., polyolefin polymers, biodegradable polymers, acrylic polymers, etc.), a polymer gel (e.g., mixture of a suitable polymer and water), a wax (e.g., paraffin) and silica gels.

Polymer:

In one embodiment, the corrosion inhibiting formula according to the present invention comprises a mixture of: (i) at least one volatile corrosion inhibitor (VCI); (ii) at least one antioxidant; (iii) one or more alkali or alkaline-earth metal silicates; and (iv) fumed silica, which is combined with a small amount of polymer or resin material (which acts as the carrier) to form a corrosion inhibiting mixture.

In another embodiment, the present invention relates to corrosion inhibiting formulas which comprise a mixture of: (i) at least one volatile corrosion inhibitor (VCI); (ii) at least one antioxidant; (iii) one or more alkali or alkaline-earth metal silicates; (iv) fumed silica; and (v) at least one chemically active compound, which is combined with a small amount of polymer or resin material (which acts as the carrier) to form a corrosion inhibiting mixture.

As previously discussed, this mixture can, if desired, be combined with a suitable amount of an additional polymer or resin and further processed by known techniques (e.g., extrusion, co-extrusion, coating, casting, etc.) to produce a polymer film or polymer article. The polymer used for the carrier portion can be identical to or different from that utilized for the polymer article forming portion.

In one embodiment, suitable polymers for either the carrier or the polymer article forming portion include polyolefin polymers and copolymers of polyolefins. Exemplary polyolefins include, but are not limited to, polyethylenes, polypropylenes, polybutenes and polyisoprenes. In another embodiment, polymers such as ethylene/vinyl acetate copolymers, ethylene/vinyl chloride copolymers, polyvinyl chloride polymers, polyurethane polymers, polyester polymers, polyacrylic polymers (both crosslinked and non-crosslinked) and copolymers of one or more of the above can be utilized in the present invention as a carrier and/or as the polymer article forming portion of the present invention. Such copolymers could include two or more of the same type of monomer, for example, two or more different olefins.

In yet another embodiment, the carrier and or polymer article forming portion for the aforementioned corrosion inhibiting mixture is a biodegradable polymer. Any polymer which exhibits biodegradability can be utilized in conjunction with the present invention. Examples of suitable biodegradable polymers include, but are not limited to, biodegradable polyesters (e.g., linear poly ε-carpolactone (PCL)), biodegradable polylatic acid polymers, biodegradable polyester amide polymers, biodegradable polyester urethane polymers and biodegradable copolymers of any combination of two or more of the above. Such copolymers could include two or more of the same type of polymer, for example, two or more different biodegradable polyesters.

Furthermore, the aforementioned corrosion inhibiting mixture can be added to an additional amount of some or all of the above polymer compositions and further processed by known techniques (e.g., extrusion, co-extrusion, blow molding, etc.) to produce a polymer film or polymer article which contains therein a vapor phase or volatile corrosion inhibitor.

U.S. Pat. Nos. 5,801,224 and 5,969,089 disclose aliphatic polyesters which are formed by a bulk extrusion polymerization process. These two patents are hereby incorporated by reference in their entirety for the disclosure regarding polyester polymers and their teachings as to how to produce same. The polymers disclosed in U.S. Pat. Nos. 5,801,224 and 5,969,089 can be utilized in the present invention both as a carrier and as the polymer article forming portion which contains the above-mentioned corrosion inhibiting mixture.

In one embodiment, the weight ratio of compounds (i) to (iv) (or (i) to (v)) to polymer in the corrosion inhibiting polymer mixture is from about 1:1 to about 1:200, or from about 1:25 to about 1:150, or even from about 1:50 to about 1:100. In another embodiment, the weight ratio of compounds (i) to (iv) (or (i) to (v)) to polymer in the corrosion inhibiting polymer mixture is from about 1:1 to about 1: 10, or from about 1:1 to about 1:5, or even from about 1:1 to about 1:3.

The corrosion inhibiting polymer mixtures are produced by mixing all of the components (i) to (iv) (or (i) to (v)) together with a suitable amount of one or more carriers (e.g., a suitable polymer composition) and extruding, coating or casting the mixture at a temperature of above about 150° F., or above about 200° F., or even above about 250° F.

Additional Additives:

In addition to components (i) to (iv) (or (i) to (v)), the corrosion inhibiting mixtures of the present invention can optionally include additional additives such as processing aids such as plasticizers (e.g., dioctyl phthalate, tricrecyl phosphate, etc.) and/or other additives such as fillers, colorants, slip agents, lubricants, tackifiers, anti-bacterials, anti-statics, anti-mildew agents, anti-settling agents, UV-protectants, insecticides, pesticides, oils (including biodegradable oils), etc.

Biodegradable oils include, but are not limited to fish oils, vegetable oils, lanolins, synthetic esters, low molecular weight polyalfaolefins, polybutenes and polyalkylene glycols. Examples of suitable vegetable oils include, but are not limited to, rapeseed oil, canola oil, soybean oil, corn oil, cottonseed oil, linseed oil, olive oil, tung oil, peanut oil, meadowfoam oil, sunflower oil, safflower oil, jojoba oil, palm oil, castor oil, among others.

In another embodiment, when an oil is added to a corrosion inhibiting mixture according to the present invention an anti-settling agent is utilized to prevent the corrosion inhibiting mixture from settling out. Such a combination yields a corrosion inhibiting oil mixture which can be applied to various articles.

In one embodiment, the corrosion inhibiting mixtures of the present invention are acid-free (i.e., the mixtures contain no acidic compounds). For example, in one embodiment, acid free can mean having a pH of more than about 5, or more than about 6, or even more than about 7.

In another embodiment, a corrosion inhibiting mixture according to the present invention optionally contains an odor-suppressing compound. Such compounds include, but are not limited to, iron oxides (both ferrous oxide and ferric oxide), cobalt oxide, nickel oxide, copper oxides (both cuprous oxide and cupric oxide), zinc oxide, magnesium oxide and calcium oxide.

In yet another embodiment, a corrosion inhibiting mixture according to the present invention can be added to a biodegradable solvent. Biodegradable solvents are known in the art and as such a discussion hereof is omitted. Such a mixture can optionally include an anti-settling agent if necessary to keep the corrosion inhibiting mixture according to the present invention from “settling out”.

### EXAMPLES

The present invention is further illustrated by the following examples wherein the term parts refers to parts by weight unless otherwise indicated. The following examples are not meant to be limiting, rather the are illustrative of only a few embodiments within the scope of the present invention.

Examples 1, 3, 5, 7 and 9 describe the preparation of corrosion inhibiting mixtures in a polymer carrier. Examples 2, 4, 6, 8 and 10 describe the preparation of polymer films utilizing the corrosion inhibiting mixtures of Examples 1, 3, 5, 7 and 9, respectively.

### Example 1

| | |
|---|---|
| Sodium Nitrite | 2.5 parts |
| Sodium Silicate¹ | 0.2 parts |
| “Ionol”² | 0.5 parts |
| “Cab-O-Sil”³ | 0.1 parts |
| “Microthene FE-532” organic polymer⁴ | 7.0 parts |

¹Sodium Silicate is a glassy product with a weight ratio of silica to sodium oxide of 2 (commercially available from the PQ Corporation).
²“Ionol” is 2,6-di-tert-butyl-4-methyl phenol (commercially available from the Uniroyal Chemical Company).
³“Cab-O-Sil” is fumed silica (commercially available from the Cabot Corporation).
⁴“Microthene FE-532” is ethylene/vinyl acetate copolymer (commercially available from U.S. Industrial Chemical Corporation).

The corrosion inhibiting mixture contained in the above-mentioned polymer carrier is formed by extruding the mixture above about 250° F. The corrosion inhibiting mixture according to Example 1 shows little degradation and demonstrates excellent corrosion-inhibiting properties using test method FTM-1016 (Method 4031).

### Example 2

This Example describes a volatile corrosion-inhibiting article in the form of an extruded thermoplastic film which is formed by combining the corrosion inhibiting mixture of Example 1 with a suitable amount of polymer. This mixture is then extruded and blown into a film at a temperature above about 300° F. The resultant film shows no discoloration or gas formation and possesses excellent corrosion-inhibiting properties when tested against mild steel using test methods FTM-101B (Method 4031) and ASTM D 1735-92.

The film according to this Example is formed as noted above by uniformly mixing a combination of the following ingredients:

| | |
|---|---|
| The mixture of Example 1 | 3 parts |
| Low density polyethylene | 97 parts |

### Example 3

| | |
|---|---|
| Sodium Nitrite | 2.5 parts |
| Sodium Silicate | 0.2 parts |
| “Ionol” | 0.5 parts |
| “Cab-O-Sil” | 0.1 parts |
| Biodegradable Polymer PCL⁵ | 7.0 parts |

5. Polymer PCL is biodegradable aliphatic polyester polymer. It is fully biodegradable polyester and passes the ASTM and ISO Standards of biodegradability and compostability (commercially available from Dow Chemical Corporation).

The corrosion inhibiting mixture contained in the above-mentioned polymer carrier is formed by extruding the mixture above about 200° F. The corrosion inhibiting mixture according to Example 3 shows little degradation and demonstrates excellent corrosion-inhibiting properties using test method FTM-101B (Method 4031).

### Example 4

This Example describes a volatile corrosion-inhibiting article in the form of an extruded thermoplastic film which is formed by combining the corrosion inhibiting mixture of Example 3 with a suitable amount of polymer. This mixture is then extruded and blown into a film at a temperature above about 250° F. The resultant film shows no discoloration or gas formation and possesses excellent corrosion-inhibiting properties when tested against mild steel using test methods FTM-101B (Method 4031) and ASTM D 1735-92.

The film according to this Example is formed as noted above by uniformly mixing a combination of the following ingredients:

| | |
|---|---|
| The mixture of Example 3 | 2 parts |
| Linear poly (ε-carpolactone) (PCL) | 98 parts |

### Example 5

| | |
|---|---|
| Sodium Nitrite | 2.5 parts |
| Sodium Silicate | 0.2 parts |
| “Cobratec TT-85”⁶ | 0.5 parts |
| “Ionol” | 0.5 parts |
| “Cab-O-Sil” | 0.1 parts |
| Polymer PCL⁵ | 7.0 parts |

⁶“Cobratec TT-85” is sodium tolyltriazole, a corrosion inhibitor commercially available from the Sherwin-Williams Company.

The corrosion inhibiting mixture contained in the above-mentioned polymer carrier is formed by extruding the mixture above about 200° F. The corrosion inhibiting mixture according to Example 5 shows little degradation and demonstrates excellent corrosion-inhibiting properties using test method FTM-101B (Method 4031).

### Example 6

This Example describes a volatile corrosion-inhibiting article in the form of an extruded thermoplastic film which is formed by combining the corrosion inhibiting mixture of Example 5 with a suitable amount of polymer. This mixture is then extruded and blown into a film at a temperature above about 250° F. The resultant film shows no discoloration or gas formation and possesses excellent corrosion-inhibiting properties when tested against mild steel using test methods FTM-101B (Method 4031) and ASTM D 1735-92.

The film according to this Example is formed as noted above by uniformly mixing a combination of the following ingredients:

| | |
|---|---|
| The mixture of Example 5 | 2 parts |
| Polymer PCL⁵ | 98 parts |

### Example 7

| | |
|---|---|
| Sodium Nitrite | 2.5 parts |
| Potassium Silicate⁷ | 0.2 parts |
| “Ionol” | 0.5 parts |
| “Cab-O-Sil” | 0.1 parts |
| “Microthene FE-532” organic polymer | 7.0 parts |

⁷Potassium Silicate is glassy product with a weight ratio of silica to potassium oxide of 2.5 (commercially available from the PQ Corporation).

The corrosion inhibiting mixture contained in the above-mentioned polymer carrier is formed by extruding the mixture above about 250° F. The corrosion inhibiting mixture according to Example 7 shows little degradation and demonstrates excellent corrosion-inhibiting properties using test method FTM-101B (Method 4031).

### Example 8

This Example describes a volatile corrosion-inhibiting article in the form of an extruded thermoplastic film which is formed by combining the corrosion inhibiting mixture of Example 7 with a suitable amount of polymer. This mixture is then extruded and blown into a film at a temperature above about 300° F. The resultant film shows no discoloration or gas formation and possesses excellent corrosion-inhibiting properties when tested against mild steel using test methods FTM-101B (Method 4031) and ASTM D 1735-92.

The film according to this Example is formed as noted above by uniformly mixing a combination of the following ingredients:

| | |
|---|---|
| The mixture of Example 7 | 3 parts |
| Low density polyethylene | 97 parts |

### Example 9

| | |
|---|---|
| Sodium Nitrite | 2.5 parts |
| Sodium Silicate | 0.2 parts |
| “Ionol” | 0.5 parts |
| “Cobratec TT-85” | 0.5 parts |
| Zinc Oxide | 1.0 parts |
| “Cab-O-Sil” | 0.1 parts |
| Polymer PCL⁵ | 7.0 parts |

The corrosion inhibiting mixture contained in the above-mentioned polymer carrier is formed by extruding the mixture above about 200° F. The corrosion inhibiting mixture according to Example 9 shows little degradation and demonstrates excellent corrosion-inhibiting properties using test method FTM-101B (Method 4031).

### Example 10

This Example describes a volatile corrosion-inhibiting article in the form of an extruded thermoplastic film which is formed by combining the corrosion inhibiting mixture of Example 9 with a suitable amount of polymer. This mixture is then extruded and blown into a film at a temperature above about 250° F. The resultant film shows no discoloration or gas formation and possesses excellent corrosion-inhibiting properties when tested against mild steel and non-ferrous metals such as copper, brass and aluminum using test methods FTM-101 B (Method 4031) and ASTM D 1735-92.

The film according to this Example is formed as noted above by uniformly mixing a combination of the following ingredients:

| | |
|---|---|
| The mixture of Example 9 | 3 parts |
| Polymer PCL⁵ | 97 parts |

Although the present invention has been shown and described with respect to certain embodiments, it is obvious that equivalent alterations and modifications will occur to others skilled in the art upon the reading and understanding of this specification. In particular with regard to the various functions performed by the above described components, the terms (including any reference to a “means”) used to describe such components are intended to correspond, unless otherwise indicated, to any component which performs the specified function of the described component (e.g., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more other features of the other embodiments as may be desired and advantageous for any given or particular application.

What is claimed is:

1. A corrosion inhibiting mixture comprising:
(i) at least one volatile corrosion inhibitor;
(ii) at least one antioxidant;
(iii) at least one alkali or alkaline-earth metal silicate or oxide; and
(iv) fumed silica.

2. The corrosion inhibiting mixture of claim 1, wherein component (i) is selected from inorganic nitrite salts, triazole compounds and mixtures of two or more thereof.

3. The corrosion inhibiting mixture of claim 2, wherein component (i) is selected from sodium nitrite, potassium nitrite, barium nitrite and mixtures of two or more thereof.

4. The corrosion inhibiting mixture of claim 2, wherein component (i) is selected from benzotriazole, tolyltriazole, sodium tolyltriazole and mixtures of two or more thereof.

5. The corrosion inhibiting mixture of claim 1, wherein component (ii) is selected from tri-substituted phenols substituted in the 2, 4 and 6 positions with one or more alkyl, hydroxyalkyl, aryl, alkenyl or hydroxyalkenyl groups having the general formula: 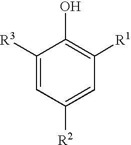
wherein the sum of the carbon atoms present in the substituent groups R¹, R² and R³ is in the range of 3 to about 36.

6. The corrosion inhibiting mixture of claim 1, wherein component (ii) is selected from tri-substituted phenols substituted in the 2, 4 and 6 positions with one or more alkyl, hydroxyalkyl, aryl, alkenyl or hydroxyalkenyl groups having the general formula: 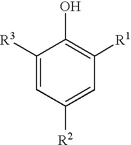
wherein the sum of the carbon atoms present in the substituent groups R¹, R² and R³ is in the range of 3 to about 18.

7. The corrosion inhibiting mixture of claim 1, wherein component (iii) is a silicate compound selected from lithium silicate, sodium silicate, potassium silicate, barium silicate and mixtures of two or more thereof.

8. The corrosion inhibiting mixture of claim 1, wherein component (iii) is a oxide compound selected from magnesium oxide, calcium oxide, strontium oxide, barium oxide and mixtures of two or more thereof.

9. The corrosion inhibiting mixture of claim 1, wherein component (iii) is a mixture of:
(A) at least one silicate compound selected from lithium silicate, sodium silicate, potassium silicate and barium silicate; and
(B) at least one oxide compound selected from magnesium oxide, calcium oxide, strontium oxide and barium oxide.

10. The corrosion inhibiting mixture of claim 1, further comprising a carrier.

11. The corrosion inhibiting mixture of claim 10, wherein the carrier is selected from at least one polymer composition or resin composition, at least one polymer gel, at least one wax, silica gels and combinations of two or more thereof.

12. The corrosion inhibiting mixture of claim 10, wherein the carrier is a polyolefin polymer or copolymer.

13. The corrosion inhibiting mixture of claim 10, wherein the carrier is at least one polymer selected from polyethylene polymers, polypropylene polymers, polybutenes polymers, polyisoprene polymers and copolymers of two or more thereof.

14. The corrosion inhibiting mixture of claim 10, wherein the carrier is at least one polymer selected from ethylene/vinyl acetate copolymers, ethylene/vinyl chloride copolymers, polyvinyl chloride polymers, polyurethane polymers, polyester polymers, polyacrylic polymers and copolymers of two or more of the above.

15. The corrosion inhibiting mixture of claim 10, wherein the carrier is at least one biodegradable polymer or copolymer.

16. The corrosion inhibiting mixture of claim 15, wherein the biodegradable polymer or copolymer is selected from biodegradable polyesters, biodegradable polylatic acid polymers, biodegradable polyester amide polymers, biodegradable polyester urethane polymers and biodegradable copolymers of any combination of two or more of the above.

17. The corrosion inhibiting mixture of claim 15, wherein the biodegradable polymer is linear poly ε-carpolactone.

18. The corrosion inhibiting mixture of claim 10, further comprising at least one plasticizer, filler, colorant, slip agent, lubricant, tackifier, anti-bacterial, anti-static, anti-mildew agent, anti-settling agent, UV-protectant, insecticide, pesticide, oil or mixtures of two or more thereof.

19. A corrosion inhibiting polymer article comprising:
about one part to about ten parts of a corrosion inhibiting mixture contained in a carrier the corrosion inhibiting mixture comprising:
(i) at least one volatile corrosion inhibitor;
(ii) at least one antioxidant;
(iii) at least alkali or alkaline-earth metal silicate or oxide; and
(iv) fumed silica,
and about ninety to about ninety-nine parts of at least one polymer composition or resin composition.

20. The corrosion inhibiting polymer article of claim 19, which comprises about one part to about five parts of the corrosion inhibiting mixture contained in the carrier and about ninety-five to about ninety-nine parts of at least one polymer composition or resin composition.

21. The corrosion inhibiting polymer article of claim 19, which is a film.

22. A corrosion inhibiting mixture comprising the following components:
(i) at least one volatile corrosion inhibitor;
(ii) at least one antioxidant;
(iii) at least one alkali or alkaline-earth metal silicate or oxide;
(iv) fumed silica; and
(v) at least one chemically active compound.

23. The corrosion inhibiting mixture of claim 22, wherein component (i) is selected from inorganic nitrite salts, triazole compounds and mixtures of two or more thereof.

24. The corrosion inhibiting mixture of claim 23, wherein component (i) is selected from sodium nitrite, potassium nitrite, barium nitrite and mixtures of two or more thereof.

25. The corrosion inhibiting mixture of claim 23, wherein component (i) is selected from benzotriazole, tolyltriazole, sodium tolyltriazole and mixtures of two or more thereof.

26. The corrosion inhibiting mixture of claim 22, wherein component (ii) is selected from tri-substituted phenols substituted in the 2, 4 and 6 positions with one or more alkyl, hydroxyalkyl, aryl, alkenyl or hydroxyalkenyl groups having the general formula: 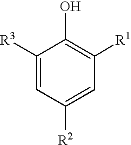
wherein the sum of the carbon atoms present in the substituent groups R¹, R² and R³ is in the range of 3 to about 36.

27. The corrosion inhibiting mixture of claim 22, wherein component (ii) is selected from tri-substituted phenols substituted in the 2, 4 and 6 positions with one or more alkyl, hydroxyalkyl, aryl, alkenyl or hydroxyalkenyl groups having the general formula: 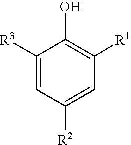
wherein the sum of the carbon atoms present in the substituent groups R¹, R² and R³ is in the range of 3 to about 18.

28. The corrosion inhibiting mixture of claim 22, wherein component (iii) is a silicate compound selected from lithium silicate, sodium silicate, potassium silicate, barium silicate and mixtures of two or more thereof.

29. The corrosion inhibiting mixture of claim 22, wherein component (iii) is a oxide compound selected from magnesium oxide, calcium oxide, strontium oxide, barium oxide and mixtures of two or more thereof.

30. The corrosion inhibiting mixture of claim 22, wherein component (iii) is a mixture of:
(A) at least one silicate compound selected from lithium silicate, sodium silicate, potassium silicate and barium silicate; and
(B) at least one oxide compound selected from magnesium oxide, calcium oxide, strontium oxide and barium oxide.

31. The corrosion inhibiting mixture of claim 22, further comprising a carrier.

32. The corrosion inhibiting mixture of claim 31, wherein the carrier is selected from at least one polymer composition, at least one resin composition, at least one polymer gel, at least one wax, silica gels and combinations of two or more thereof.

33. The corrosion inhibiting mixture of claim 31, wherein the carrier is a polyolefin polymer or copolymer.

34. The corrosion inhibiting mixture of claim 31, wherein the carrier is at least one polymer selected from polyethylene polymers, polypropylene polymers, polybutenes polymers, polyisoprene polymers and copolymers of two or more thereof.

35. The corrosion inhibiting mixture of claim 31, wherein the carrier is at least one polymer selected from ethylene/vinyl acetate copolymers, ethylene/vinyl chloride copolymers, polyvinyl chloride polymers, polyurethane polymers, polyester polymers, polyacrylic polymers and copolymers of two or more of the above.

36. The corrosion inhibiting mixture of claim 31, wherein the carrier is at least one biodegradable polymer or copolymer.

37. The corrosion inhibiting mixture of claim 36, wherein the biodegradable polymer or copolymer is selected from biodegradable polyesters, biodegradable polylatic acid polymers, biodegradable polyester amide polymers, biodegradable polyester urethane polymers and biodegradable copolymers of any combination of two or more of the above.

38. The corrosion inhibiting mixture of claim 36, wherein the biodegradable polymer is linear poly ε-carpolactone.

39. The corrosion inhibiting mixture of claim 22, wherein component (v) is selected from iron oxides, cobalt oxide, nickel oxide, copper oxides, zinc oxide and mixtures of two or more thereof.

40. The corrosion inhibiting mixture of claim 39, wherein component (v) is selected from iron oxides, zinc oxide and mixtures of two or more thereof.

41. The corrosion inhibiting mixture of claim 31, further comprising at least one plasticizer, filler, colorant, slip agent, lubricant, tackifier, anti-bacterial, anti-static, anti-mildew agent, anti-settling agent, UV-protectant, insecticide, pesticide, oil or mixtures of two or more thereof.

42. A corrosion inhibiting polymer article comprising:
about one part to about ten parts of a corrosion inhibiting mixture contained in a carrier the corrosion inhibiting mixture comprising:
(i) at least one volatile corrosion inhibitor;
(ii) at least one antioxidant;
(iii) at least one alkali or alkaline-earth metal silicate or oxide;
(iv) fumed silica; and
(v) at least one chemically active compound,
and about ninety to about ninety-nine parts of at least one polymer composition or resin composition.

43. The corrosion inhibiting polymer article of claim 42, which comprises about one part to about five parts of the corrosion inhibiting mixture contained in the carrier and about ninety-five to about ninety-nine parts of the at least one polymer composition or resin composition.

44. The corrosion inhibiting polymer article of claim 42, which is a film.
